(19) United States
(12) Patent Application Publication
(10) Pub. No.: US 2003/0014229 A1
(43) Pub. Date: Jan. 16, 2003

(54) Process and system for automatically constructing a bayes network

(76) Inventors: Michael Borth, Ulm (DE); Hermann Von Hasseln, Esslingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/191,797

(22) Filed: Jul. 10, 2002

(30) Foreign Application Priority Data
Jul. 10, 2001 (DE) 101 33 375.7

(51) Int. Cl. G06F 7/60

(52) U.S. Cl. 703/2; 703/8

(57) ABSTRACT

A process for constructing a Bayes network for the imaging and diagnosis of a technical system by means of a system description includes the following steps: constructing a system input node for each system input of the system; constructing a system output node for each system output of the system; imaging all components of the system by means of component state nodes, component input nodes and component output nodes; constructing linkages between component state nodes of different components by means of direct logical and/or causal relationships between function states of components; constructing linkages between component output nodes and component input nodes of different components by means of flows of material, energy and/or information in the system; constructing linkages between system input nodes and component input nodes by means of flows of material, energy and/or information in the system; and constructing linkages between component output nodes and system output nodes by means of flows of material, energy and/or information in the system.

### BACKGROUND AND SUMMARY OF THE INVENTION

This application claims the priority of German patent document 101 33 375.7, filed Jul. 10, 2002, the disclosure of which is expressly incorporated by reference herein.

The invention relates to a process for constructing a Bayes network for imaging and diagnosis of a technical system by means of a system description, particularly for a motor vehicle.

Highly complex technical systems are used in modern motor vehicles. The task of diagnosis for such systems is therefore also highly complex, and requires the processing of incomplete and uncertain knowledge. Bayes networks are particularly suitable for this purpose because they explicitly represent relevant relationships by graphical modeling of causal influences, for example, by vectored edges. In this case, existing knowledge concerning the uncertainty of the represented relationships is coded by probability distributions which are assigned to the network, thereby facilitating efficient processing of the existing knowledge and of the existing uncertainty within the same structure, based on classical probability theory. Bayes networks are also called causal networks, belief networks or influence diagrams.

The manual construction of Bayes networks is known. In this case, the knowledge required for solving an application task is recorded and imaged in suitable forms. This knowledge is available to application experts on the basis of their education and experience as well as on the basis of accessible sources of knowledge.

For constructing a Bayes network, all differentiable relevant quantities of the application field are recorded. A relevant quantity may take on various conditions or states, in which case mutually clearly separated and/or discrete states are just as conceivable as continuous value ranges. The relevance of a quantity is demonstrated by the fact that different states of the quantity have different effects within the system, or that they are generated by different causes and can possibly be observed. The relevant quantities are converted to variables for the Bayes network and their possible different states are converted to possible states of the other variables. These variables are represented as nodes in the Bayes network.

Furthermore, dependencies between the quantities or variables are recorded. If one variable is a function of another, a vectored connection is inserted between the corresponding nodes. In this case, the direction of the connection extends from the causing to the dependent variable.

In addition, the required probabilities are determined. For this purpose, the occurrence probabilities of the states of all variables which are not dependent on another variable, must be defined. In the case of dependent variables, the occurrence probabilities of their states must be determined as a function of the states of the causing variable. Thus, a separate determination of probabilities is required for any possible combination of states.

Bayes networks can be implemented manually for individual systems which are not too complex. However, the expenditures can no longer be managed when many systems or partial systems have to be modeled. This also applies because the product cycles, for example, of motor vehicles, are becoming progressively shorter so that the previously generated Bayes networks frequently have to be adapted. For a motor vehicle, in particular it should be noted that just the representation of the electrical system alone would far exceed the limits of the manual construction of a Bayes network.

Another disadvantage of the manual construction of Bayes networks is the fact that the constructing person images his or her knowledge concerning the relationships of the system in question from his or her own point of view. This process is naturally highly subjective. Even a single constructor would be unable to design several networks completely consistently. This effect is intensified when various experts have the task of constructing Bayes networks. When representing partial systems, compatibility problems occur in the network fragments, so that they cannot easily be assembled to a total network. Problems may also occur in separate systems such that the results are not comparable.

In general, processes of mechanical learning are known in which information concerning a system can be derived from a large number of similar data sets (so-called data miming or knowledge discovery in databases), based on statistical principles. On the one hand, these processes require very large data quantities which do not exist especially for technical systems in the development stage. On the other hand, various measures (for example, adjustment of the learning parameters, which have a decisive influence on the result) must be carried by experts. Thus, no uniform quality of the derived information can be expected for different systems. For the automatic construction of compatible Bayes networks for diagnosing technical systems, these processes of mechanical learning therefore have several disadvantages.

One object of the present invention is to provide a process and a system for constructing Bayes networks for the imaging and diagnosis of a technical system by means of which compatible networks or network fragments can be automatically constructed.

This and other objects and advantages are achieved according to the invention, by a process for constructing a Bayes network for the imaging and diagnosis of a technical system by means of a system description, particularly for a motor vehicle, which process includes the following steps:

constructing a system input node for each system input of the system;

constructing a system output node for each system output of the system;

imaging all components of the system by means of component state nodes, component input nodes and component output nodes;

constructing linkages between component state nodes of different components by means of direct logical and/or causal relationships between states of components;

constructing linkages between component output nodes and component input nodes of different components by means of flows of material, energy and/or information in the system;

constructing linkages between system input nodes and component input nodes by means of flows of material, energy and/or information in the system; and

constructing linkages between component output nodes and system output nodes by means of flows of material, energy and/or information in the system.

Because a Bayes network comprises defined process steps according to given systematics, automatic construction is possible, and the constructed networks or network fragments will be mutually compatible. Since the Bayes network is constructed on the basis of a system description of the technical system, machine-readable documents, such as CAD/CAM data files, data records for simulation programs, circuit diagrams and the like can be utilized as a system description. In the case of the construction of a motor vehicle, for example, such a system description is available in very detailed form. All data required for the implementation of the process steps according to the invention can be extracted from a mechanically readable system description.

The systematic imaging of a machine-readable system description in a Bayes network permits efficient generation of Bayes networks, such that the construction can be performed automatically by means of a data processing system, and an operator is not required to have expert knowledge. If, within a technical application field (for example, with respect to a vehicle), a library is constructed of network fragments representing individual system components, by assembling such network fragments, comparatively rapid construction of a Bayes network is possible, which makes only minor demands on the system description because a considerable part of the knowledge concerning the technical system is already coded in the network. The construction of such a library of compatible network fragments is considerably facilitated by the process according to the invention.

The object of the invention is also achieved by a system for implementing the process according to the invention, having a source unit for the storage and/or the editing of the system description, a component analyzing unit for analysis of the system and its disassembly into components, a construction unit for constructing network fragments assigned to the components, and a completion unit for assembling the network fragments to a total network.

By means of such a system, Bayes networks can be constructed automatically, based on a system description. The division into individual units according to the invention permits an expedient implementation on a data processing system. All units of the system according to the invention can be implemented on a personal computer (PC). A constructed Bayes network can then be stored in an on-board computer of a motor vehicle for diagnostic purposes.

In the system according to the invention, a component library for storing network fragments is advantageously provided, in which case the construction unit can store network fragments in the component library and remove them from this library.

As a result, the prerequisites are established for rapidly and effectively constructing Bayes networks and for utilizing already existing knowledge. For example, in the case of a model change of a motor vehicle, only individual technical components are changed. As a result, the automatic construction of the Bayes network for the diagnosis requires comparatively low expenditures.

In a further embodiment of the system according to the invention, a setup control unit is provided in which the setup rules for network components and network linkages are filed, in which case the construction unit and the completion unit can take setup rules from the setup control unit.

For different technical systems, for example, electrical, optical and mechanical systems, different setup rules are required. By means of a setup control unit, the system according to the invention for the automatic construction of Bayes networks can be used for different technical fields of application.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic representation of a system for implementing the process according to the invention;

FIG. 2 is a schematic representation of the process according to the invention;

FIG. 3 is a detailed representation of process step 12 of FIG. 2;

FIG. 4 is a detailed representation of process step 14 of FIG. 2;

FIG. 5 is a detailed representation of process step 16 of FIG. 2;

FIG. 6 is a detailed representation of process step 18 of FIG. 2;

FIG. 7 is a detailed representation of process step 20 of FIG. 2;

FIG. 8 is a detailed representation of process step 34 of FIG. 4;

FIG. 9 is a detailed representation of process step 38 of FIG. 4;

FIG. 10 is a detailed representation of process step 40 of FIG. 4;

FIG. 11 is another schematic representation of individual process steps of the process according to the invention;

FIG. 12 is a view of a circuit diagram for illustrating the process according to the invention, in an example;

FIG. 13 is a detailed representation of network components of a Bayes network; and

FIG. 14 is a view of a Bayes network corresponding to the example of FIG. 12.

### DETAILED DESCRIPTION OF THE INVENTION

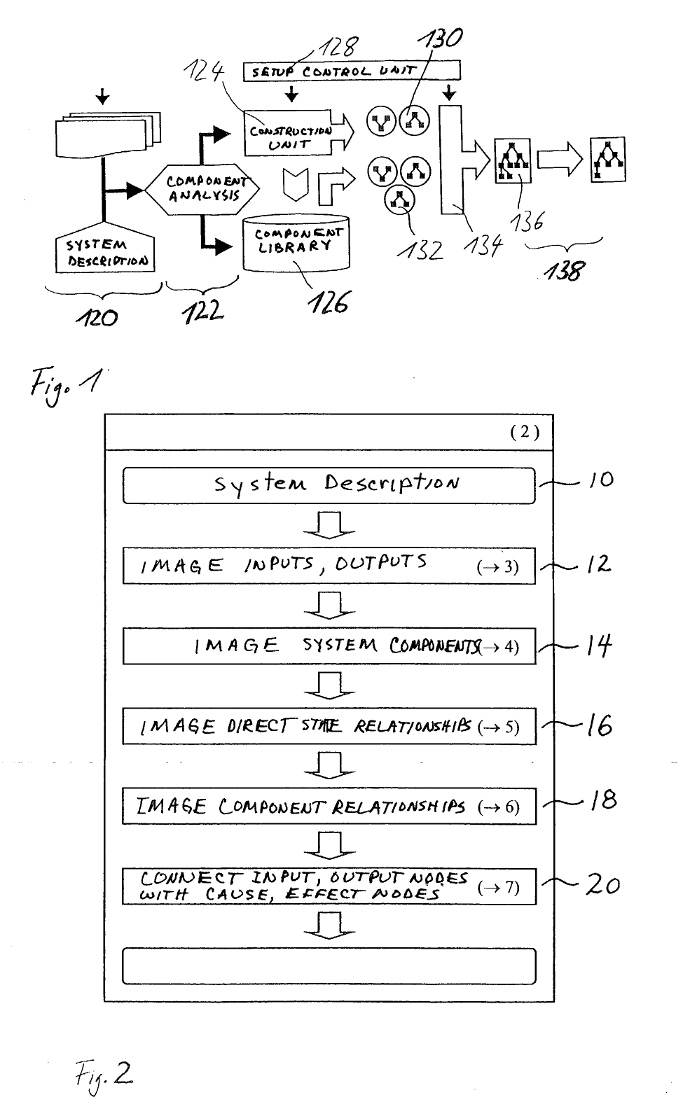

FIG. 1 schematically illustrates a system according to the invention for the automatic construction of a Bayes network for the imaging and diagnosis of a technical system by means of a system description. The system according to the invention has a source unit 120 in which a system description of the technical system is stored and which edits the system description in an appropriate manner. A component analysis unit 122 takes the required information from the source unit 120 in order to analyze the technical system, for example, the electrical system of a motor vehicle and to disassemble it into components. The component analysis unit 122 checks the found components also, to determine whether network fragments for Bayes networks are already filed in a component library 126 for components of the same type.

The construction unit 124 constructs network fragments for new components of the system for which no network fragments exist yet in the component library 126. During the construction of network fragments for new components, the construction unit 124 accesses a setup control unit 128, in which setup rules are filed for various technical fields of application. For example, network fragments which represent components of an electrical system have to be set up according to different rules than components of a mechanical system.

The construction unit 124 generates network fragments 130 for new components of the system, whereas network fragments 132 for already known components are taken out of the component library 126. The network fragments 130, 132 are then assembled to a total network 136 in a completion unit 134.

The system according to the invention also has an optimizing unit 138 in which the total network 136 is tested and is corrected, as required.

All described units of the system according to the invention are implemented in a personal computer (PC). The finished Bayes network will then be stored for diagnostic purposes in an on-board computer of a motor vehicle or in a shop computer.

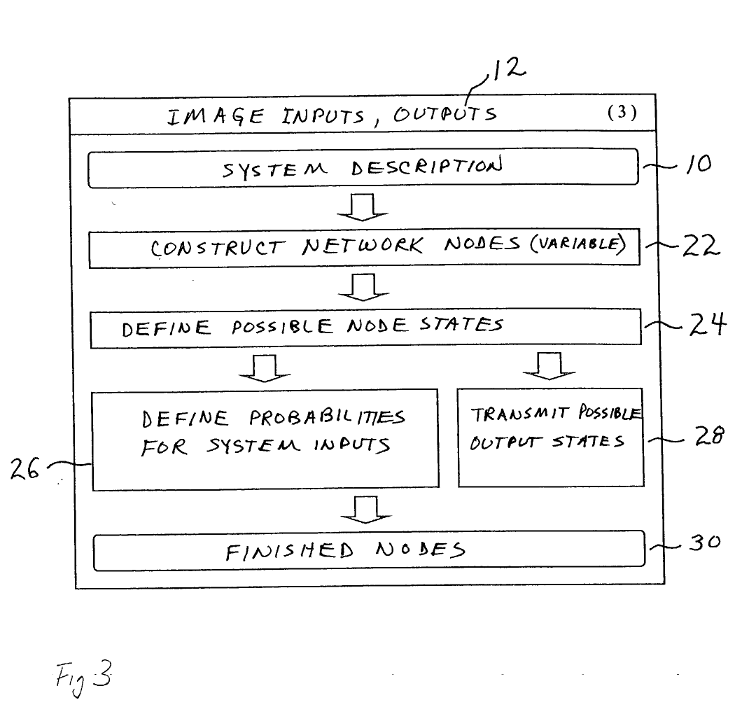

FIG. 2 depicts the imaging of a system in a Bayes network. The process according to the invention is based on a system description 10, which characterizes the technical system being considered. Technical systems, particularly motor vehicles, are generally documented in a detailed manner, for example, by means of construction documents, simulation models, instructions, repair and diagnostic information, which are present in a machine-readable form. System descriptions of this type supply information concerning the components and the structure of the system, the functionality of the components and of the system, causal relationships between system quantities, system behavior under different states, etc. If the system description correctly and completely specifies all causally acting components of the system with their conditions or states, functions and interfaces to other components and the environment, and the occurrence probabilities of the states are known, it is ensured that the generated Bayes network correctly represents the system and its behavior, which in turn ensures the possibility of an inference of observations with respect to component states that are the cause of the observations. The Bayes network is therefore suitable for diagnosis of the technical system. The system is expediently divided into components which—wherever possible—represent the smallest exchangeable units of the system.

If the system description is not complete, as described above, it can nevertheless be converted into a Bayes network. If required, the generated Bayes network can then be further refined and optimized. Such optimization can take place manually or in an automated manner.

It is the principle on which the process according to the invention is based that all causally acting components of the system are represented as nodes of the Bayes system and all interactions possibly occurring between them, such as transmitted information or physical quantities, are modeled as information flows in the network. A system component has a causal effect when, as a function of its internal state and received input quantities, it interacts with other system components, that is, supplies an output quantity which represents its function. Such a system component can be imaged as a network fragment. All input quantities, all output quantities and the internal state are imaged in network nodes which represent the respectively possible states. By means of connections from the input nodes and the state nodes to all output nodes of a component, the pertaining functions are modeled in that the pertaining occurrence probabilities are correspondingly adjusted.

By means of the process-according to the invention, a fragmentation or disaggregation of a system is performed, so that it is ensured that modeling steps are always limited to locally bounded parts of the system whose functions and interactions are known and can be represented. As a result, no limitations occur with respect to the complexity of the technical system, and all types of systems, such as electrical, optical and mechanical systems, can be modeled. Furthermore, the disaggregation of the system according to the invention permits a simple verification of the generated Bayes networks and the construction of a component library from network fragments.

Based on the system description 10, in a first step 12, the inputs and outputs of the system are imaged first. This process step is explained in greater detail in FIG. 3.

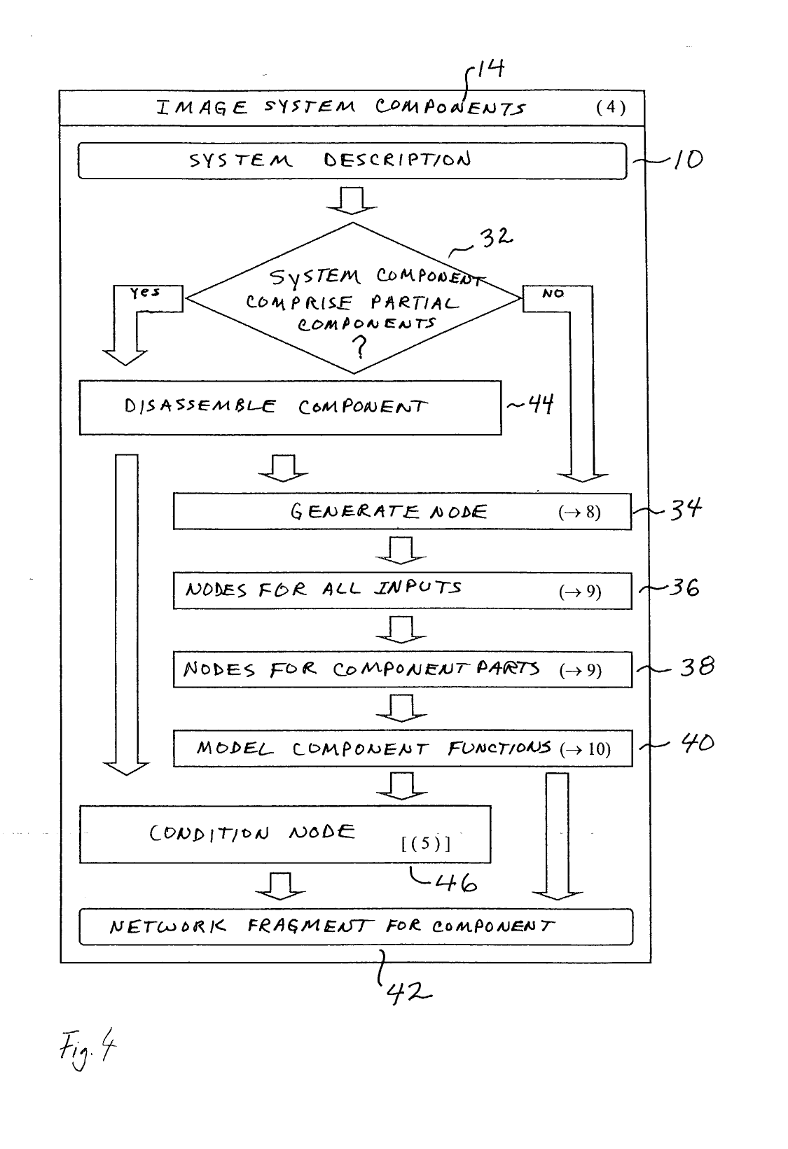

In a next process step 14, the components of the system are imaged. This process step is explained in greater detail by means of FIG. 4.

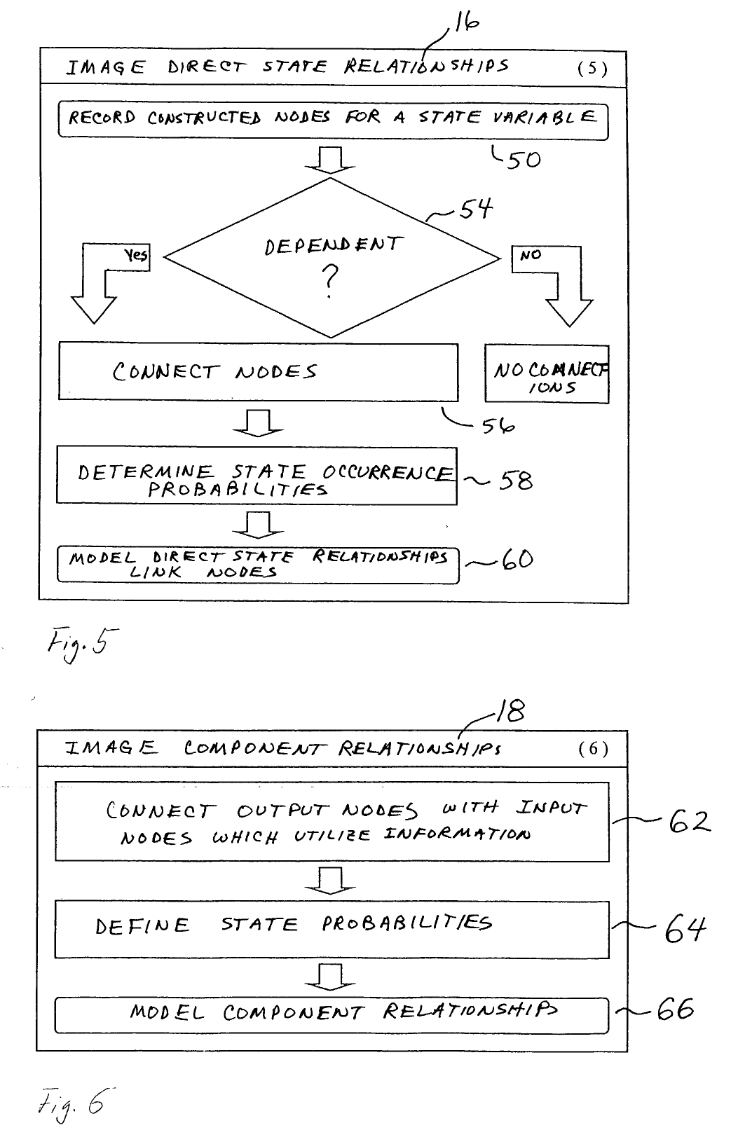

After the components of the system are imaged in step 14, direct state relationships of components are imaged in step 16. This concerns states of components which directly affect a state of another component. Process step 16 is explained in greater detail in connection with FIG. 5.

In the next process step 18, the relationships between components of the system are imaged. This process step is explained in greater detail in connection with FIG. 6.

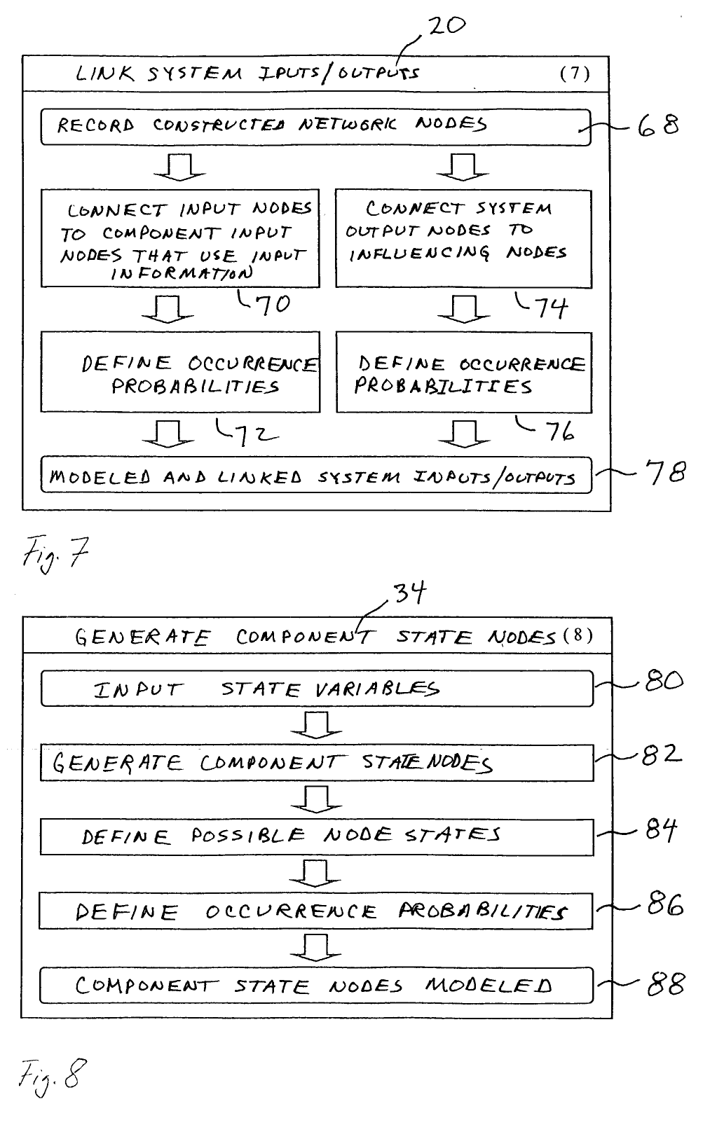

In the last process step 20, which is explained in greater detail in connection with FIG. 7, the system inputs and outputs are connected with the network node whose state they determine or which determine their states.

The use of the process according to the invention guarantees that Bayes networks for different systems have a comparable construction and furnish comparable results. This permits the construction of a component library with reusable network fragments for components. Such a component library considerably reduces the expenditures during the construction of a Bayes network. Since all constructed Bayes networks or network fragments have a comparable construction, they can be assembled to form larger networks, without difficulty.

By means of FIG. 3, process step 12 will be explained in greater detail in the following. The system description 10 contains information concerning inputs and outputs of the system. The inputs of the system or partial system are, for example, interfaces at which the control signals are transmitted. System outputs may, for example, be signal outputs at which a measured value can be tapped. For each system input and each system output, a new network node is constructed in step 22. This network node represents a variable in the Bayes network.

In the subsequent step 24, all possible states of the constructed nodes are defined. The states of the system input and system output nodes represent the possible values of the input and output variables respectively. In the case of a control signal input, a system input node can, for example, assume the ON AND OFF states. A system output node can, for example, assume the OK, NOT OK states.

After step 24, a branching takes place such that, in the case of system inputs, in step 26, the probabilities of the states are defined. These probabilities can also be taken from the system description. If no occurrence probabilities are known for the states of the system input nodes, a uniform distribution is assumed.

In contrast to system input nodes, system output nodes are not provided with occurrence probabilities. Therefore, in step 28, the possible states defined in step 24 are only transmitted. In principle, in step 28, the states of the system output nodes could also be provided with occurrence probabilities.

From steps 26 and 28, the results are transmitted to process step 30, at which the finished nodes for system inputs and system outputs are present.

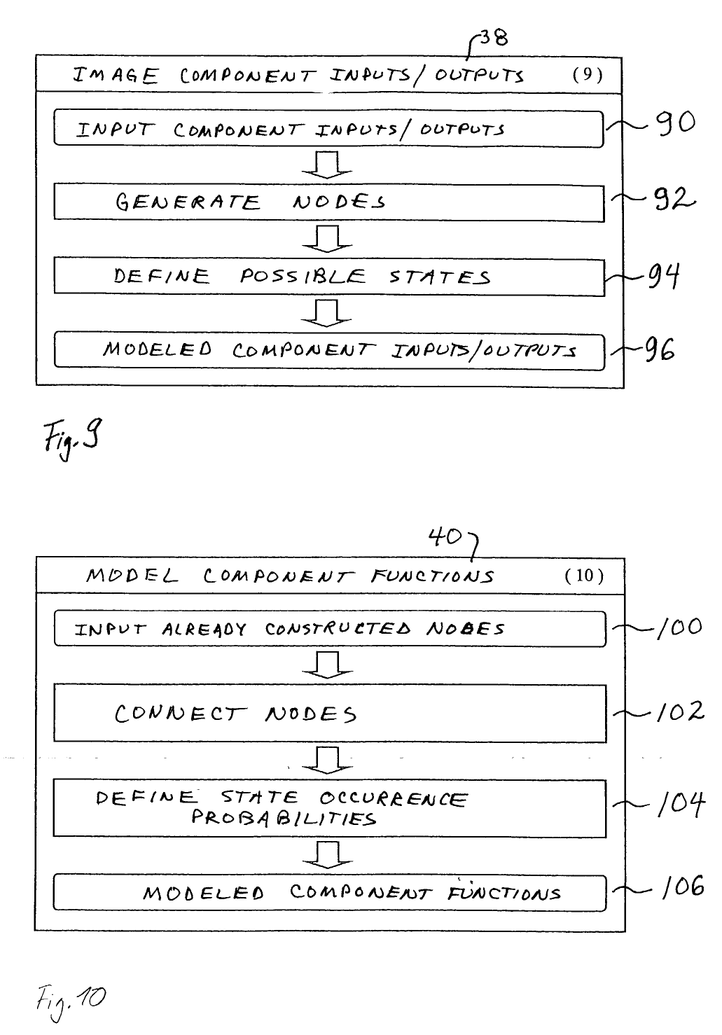

In FIG. 4, the process step 14—the imaging of components of the system in a network fragment of the Bayes network is depicted. In FIG. 4, reference number 10 indicates the system description which describes all components. The system description 10 is checked in process stop 32 with respect to whether a certain component of the system is constructed of partial components. If not, in step 34, a node is first generated for a state of the component. Process step 34 will be explained in greater detail in connection with FIG. 8.

In the subsequent step 36, nodes are generated for all inputs of the components. This applies to all inputs of a component so that in situations where an information flow in the Bayes network can take place through the components in two directions, one component input respectively is provided for each direction of the information flow. Process step 36 will be explained in greater detail in connection with FIG. 9.

Analogously, in process step 38, the nodes are generated for the component outputs. Also process step 38 is explained in greater detail in connection with FIG. 8.

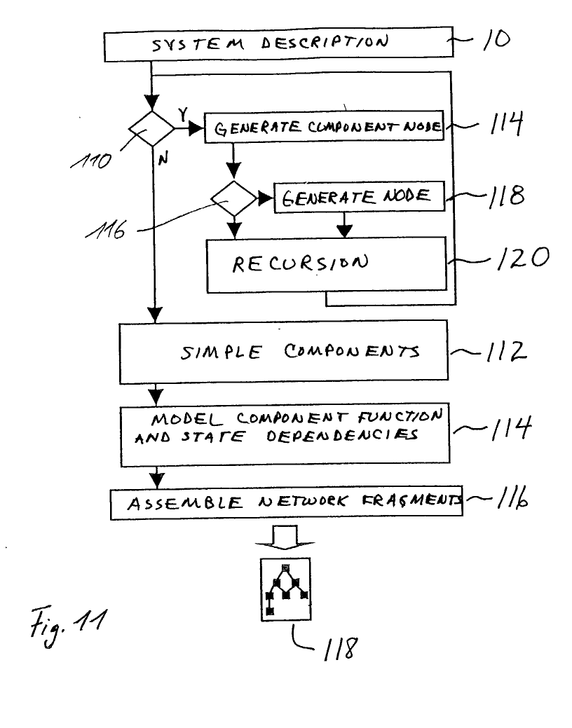

In process step 40, which is explained in greater detail in connection with FIG. 10, the functions of the components are modeled. For this purpose, connections are inserted between the nodes and occurrence probabilities are defined.

When the components are not constructed of partial components, the result of process step 40 is transmitted to process step 42, at which then a network fragment will present which images the corresponding component.

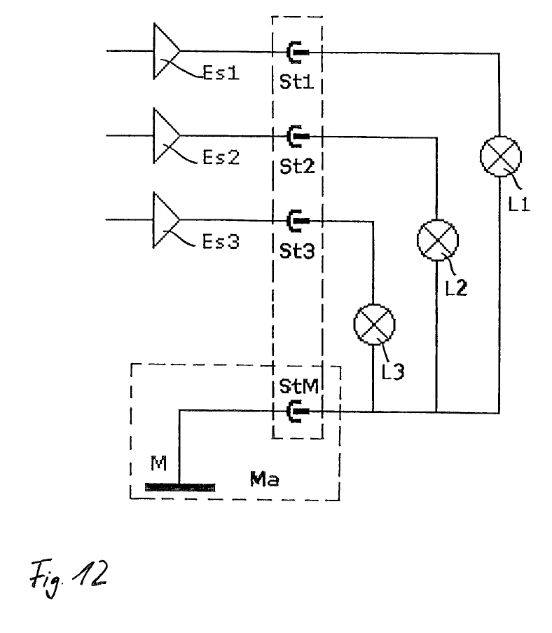

If it was determined in process step 32 that a component of the system is constructed of partial components, this component is disassembled in step 44 into partial components and steps 34 to 40 are implemented for each of the partial components. The disassembly of components constructed of partial components will also be explained by means of FIG. 11.

If a state node for the state of the total component is required for this component constructed of partial components, such a state node is generated in step 46. The linking of such state nodes for total components takes place in process step 16 which is explained in detail in connection with FIG. 5.

The results of process step 46 are transmitted to step 42 so that, after the complete implementation of process step 14, network fragments will be present for all components.

The modeling of the components with component input nodes and component output nodes, each separately for each direction of the information flow in the Bayes network, is decisive for being able to assemble the constructed network fragments to form a total network. As a result, an interface is created and the possibility is opened up of reusing once constructed network fragments. Furthermore, this construction of the network fragments permits the standardized and automated construction of a Bayes network.

FIG. 5 describes in a detailed manner process step 16 in which direct state relationships are imaged. In the first process step 50, all already constructed nodes are recorded which represent a state variable. These are, for example, component state nodes of partial components and component state nodes of the higher-ranking total components. In the case of all these nodes, it is checked in step 54 whether the state of the variables, which are represented by the node, is directly dependent on the state of another variable and thus on the state of another node. For example, the state of a higher-ranking “plug off” node has the result that all component state nodes of lower-ranking partial components (for example, the plug contacts) change into the “interrupted” state. If it is determined in step 54 that the state of one variable is directly dependent on the state of another, in step 56, connections are inserted from all influencing nodes to the influenced nodes. These connections are illustrated as arrows which, according to the information flow direction, extend from the influencing nodes to the influenced nodes. If the answer to the check in step 54 is “no”, no connections are inserted.

In the subsequent step 58, the conditional occurrence probabilities are determined for the states of the influenced node. This takes place by means of information from the system description. In the case of a withdrawn plug, the occurrence probability with respect to an interruption of the plug contacts amounts to 100 percent.

Thus, in process step 60, the direct state relationships are modeled and all nodes of the Bayes network, which directly influence one another, are linked with one another.

FIG. 6 shows the details of process step 18, in which component relationships are imaged. In this step, structural or functional connections between components are modeled.

For this purpose, all component output nodes are connected in process step 62 with that component input node respectively, which utilize the information originating from the component output nodes. In the case of an electrical system, the component output node of a light, transmits, for example, the information to the component input node of a subsequent resistor, so that the light is connected with a power source.

In the subsequent process step 64, the conditional occurrence probabilities of the states of the component input nodes are defined according to the information summary at these component input nodes. Thus, the component relationships are modeled in process step 66.

FIG. 7 shows process step 20 in detail that the system inputs and the system outputs are linked. For this purpose, in step 68, all already constructed network nodes are recorded which represent a system input or a system output. In the case of a system input, in step 70, a connection is established of the system input node to all component input nodes of components which utilize information from the system input node. In the subsequent step 72, the occurrence probabilities are defined which are caused by the relationships filed in the system description 10.

In the case of a system output, in step 74, connections are inserted from all influencing nodes to this system output node, and in step 76, the occurrence probabilities are defined which are caused by the relationships filed in the system description 10. In step 78, the modeled and linked system inputs and outputs are therefore present.

This concludes the construction of the Bayes network, in that now all components, system inputs and outputs as well as linkages are constructed.

FIG. 8 shows the details of process step 34 of FIG. 4, in which the component state nodes are generated. For this purpose, in step 80, state variables are taken from the system description 10, and in the subsequent step 82, a new component state node is generated corresponding to these variables.

In step 84, all possible states of this node are defined which correspond to possible values of the pertaining variable.

In the subsequent step 86, the occurrence probabilities of all states are defined which represent so-called a-priori probabilities. These indicate occurrence probabilities which are not caused by external influences. In step 88, the component state nodes are then modeled with possible states and occurrence probabilities.

FIG. 9 is a detailed explanation of process step 38 of FIG. 4, in which component inputs and component outputs are imaged. For this purpose, in step 90, component inputs and component outputs are taken from the system description 10. In step 92, a new node, corresponding to a variable, is generated for each component input and each component output. Then, in process step 94, all possible states of this variable are defined, so that, at step 96, the component input and the component output respectively is modeled.

FIG. 10 is a detailed explanation of process step 40 of FIG. 4, in which the component functions and partial component functions respectively are modeled. The already constructed component state nodes, component input nodes and component output nodes are used as the starting base for this purpose in step 100. In step 102, connections are inserted from all component input nodes of a component and from the pertaining component state nodes to each component output node of the components. These connections are represented by arrows from a component input node to the component output node and from the component state node to the component output nodes.

In step 104, the state occurrence probabilities are defined corresponding to the system description 10, according to the function of the components given by the system description 10. The component functions are thereby modeled in step 106.

In FIG. 11, the modeling of components, especially components consisting of partial components, is further illustrated. A differentiation is made here between components of a hierarchical construction and components which do not have a hierarchical construction. The components of a system are taken from the system description 10, and it is checked in step 110 whether a complex component is present. (A complex component is a component consisting of several partial components.) If no complex component is present in step 110, the component, which may be a partial component, will be modeled as described above.

If a complex component is present in step 110, a component state node is generated in step 114, which component state node represents the overall state of the complex component. The overall state of the complex component is determined by the states of the partial components.

It is then checked in step 116 whether the complex component represents a hierarchical component. A complex component will be called a hierarchical component when it has an additional state variable which determines the state of all partial components. A hierarchical complex component would exist in the case of a plug because a “plug withdrawn” state influences the states of all partial components—the individual plug contacts. When a hierarchical complex component is present, a node for such a state variable will be generated in step 118.

In step 120, the described process is recursively continued until all complex components are divided into simple partial components. Thus, in step 112, only simple components are present which no longer consist of partial components.

For these components, the component functions and state dependencies are modeled in step 114. Thus, network fragments exist in step 114 which will be assembled in the subsequent step 116.

In FIG. 11, reference number 118 indicates the finished Bayes network.

FIG. 12 illustrates a technical system in the form of a circuit diagram, for which the construction of a Bayes network using process according to the invention is to be illustrated as an example. The technical system illustrated in FIG. 12 represents an electrical switching circuit with three current circuits and a joint grounding conductor M. Each current circuit has an output stage Es1, Es2 and Es3 respectively, a plug pin St1, St2 and St3 respectively and a light L1, L2 and L3 respectively. The ground Ma consists of a plug pin StM as well as the grounding conductor M. The plug pins St1, St2, St3 and StM are arranged in a joint plug.

The circuit diagram illustrated in FIG. 12 represents part of the system description which is used for constructing the Bayes network. Other requirements are knowledge concerning the adjustable and observable quantities of the system, specifically the “on or off” switching states of the output stages Es1, Es2, Es3, which are switched by the user, as well as reports of the error monitoring system of the output stages, specifically “no error, error code power interruption or error code voltage”. The lights L1, L2, L3 themselves are not observable in this example.

Causally acting quantities of the system are the output stages Es1, Es2, Es3, the plug with the plug pins St1, St2, St3, StM, the lights L1, L2, L3 and the grounding conductor M.

The plug represents a hierarchical component which consists of the plug pins St1, St2, St3 and StM. The ground Ma is a virtual component which represents no exchangeable unit.

All output stages, plug pins and lights can assume three states:

OK=proper functioning

UB=interruption (defect, component interrupts power)

NS=shunt (defect, component has short circuit to battery voltage).

The ground conductor M can assume the OK or UB states. The ground Ma, as a whole, can assume the ground, UB or UB+NS states. The plug can assume the OK or “plug off” states. Furthermore, the overall state of the plug, that is, of all its plug pins St1, St2 and St3, can be described by OK or “error”.

For all states, occurrence probabilities are indicated which are known sufficiently accurately by corresponding data, such as statistics.

The states of the individual components as well as occurrence probabilities are present in a machine-readable form within the system description. For example, test data or results and data records of a simulation program can be used.

All components have two inputs and two outputs. One input and an assigned output are provided for an information flow in the direction of the current source, and the other input and the other output are provided for the information flow in the direction of the ground. From a physical point of view, each of the two contacts of each component—one in the direction of the power source and one in the direction of the ground—therefore represents an input as well as an output. Accordingly, an input may have the “source” or “no source” states, these states representing respectively a connection to an active power source or no connection. An output can assume the “ground, UB, UB+NS or NS” states, which corresponds to the functioning of its connection to the ground. As a result, the physical relationships are imaged in information flows. Deviating therefrom, the ground Ma and the output stages Es1, Es2, Es3 have only one contact direction because they are situated at the respective ends of the current circuit. However, the output stages Es1, Es2, Es3 each have an input, which accepts the input of a user, as well as an additional output which represents the error message.

The functions of the individual components are obtained from the basic rules of electrical engineering and are represented, for example, by data records of a simulation program. The function of a light L1 in state UB is, for example, such that it interrupts the current circuit. Each component function can be indicated unambiguously. This also comprises the functions of the output stages for converting the user input and for generating the error messages.

The structural relationships between components are supplied by the circuit diagram of FIG. 12 which shows which components are connected with one another in which manner. Direct relationships of states exist between the plug and the plug pins in that a “plug off” state changes all plug pins into the UB state. Such direct relationships of states also exist in the case of the ground Ma, of the grounding conductor M and of the plug pin StM.

The system description will now be imaged in a Bayes network corresponding to the process described in FIGS. 2 to 11.

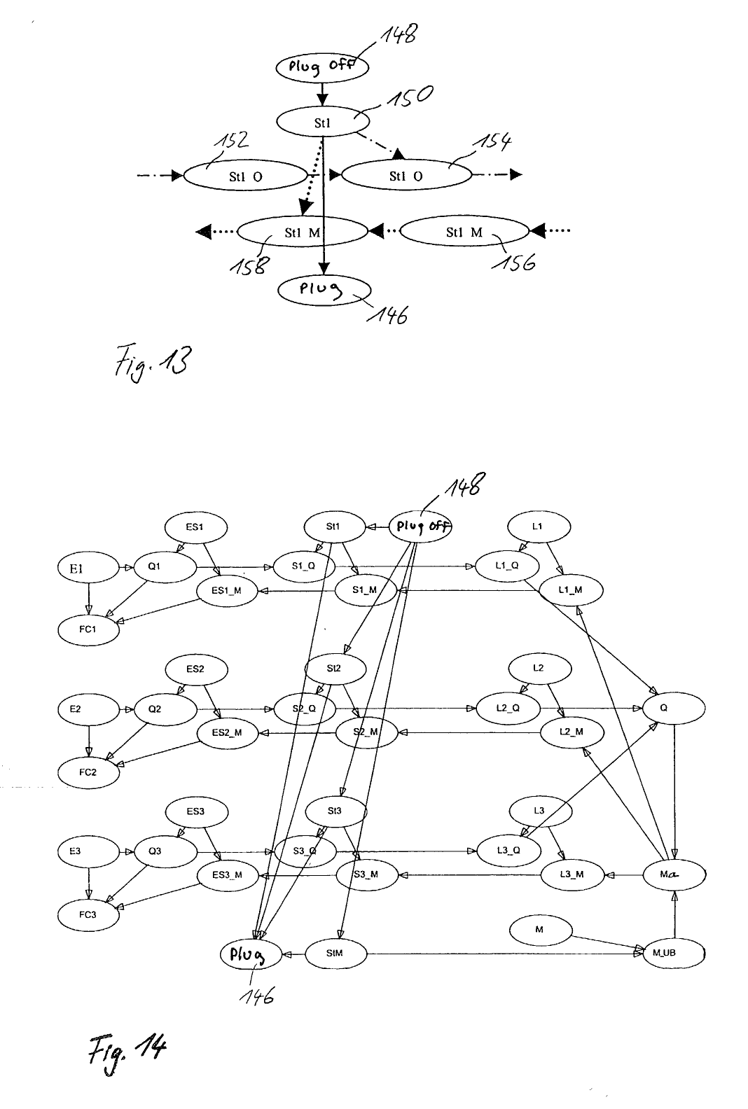

First, the construction of a network fragment for the plug is explained by means of FIG. 13. By means of the system description, it is first checked whether a complex component is present which consists of several partial components. This is so in the case of the plug, so that first a component state node 146 is generated for the overall state of the “plug” component. Further, it is checked whether the “plug” component is a hierarchical component (which it is, because the withdrawal of the plug influences the states of all plug pins). A state node 148 “plug off” is therefore generated.

Then the complex component is disassembled into simpler partial components, specifically, the individual plug pins St1, St2, St3 and StM. (For the purpose of a clearer representation, FIG. 13 shows only the network nodes for the plug pin St1.) For the plug pin St1, a component state node 150, a component input node 152 and a component output node 154 for the information flow from the source to the ground as well as a component input node 156 and a component output node 158 for the information flow from the mass to the source are constructed.

In the next step, the component functions are modeled in that, for each information flow direction separately, a connection is inserted from the component input node 152 to the component output node 154 as well as a connection from the component input node 156 to the component output node 158. The information flow direction from the source to the ground is indicated by dash-dotted arrows, and the information flow direction from the ground to the source is indicated by dotted arrows. Furthermore, connections are inserted from the component state node 150 to the component output node 158 as well as to the component output node 154. In addition, the conditional occurrence probabilities are filed in the form of truth tables in the corresponding nodes. By means of the connections between the nodes and the truth tables, which are constructed according to the system description, the function of the plug pin St1 partial component is modeled.

In the next step, direct state relationships between component state nodes are imaged. Direct state relationships are illustrated in FIG. 13 by means of continuous arrows. A connection is inserted from component state node 148 to component state node 150 because the component state “plug off” directly causes the “UB” state in the plug pin St1. Furthermore, a connection from component state node 150 to component state node 146 is inserted because an error state of the partial component St1 directly causes an error state of the plug component.

In connection with FIG. 14, the construction of the Bayes network will now be discussed for the circuit illustrated in FIG. 12. First, the system inputs and system outputs are imaged in that the nodes E1, E2 and E3 for the system inputs are generated. These nodes each have the “on” and “off” states, all states receiving the same probability.

Furthermore, three nodes FC1, FC2, FC3 for the system outputs are generated which receive the states OK, FC interruption and FC voltage.

Then, component state nodes are generated for the individual components of the system, specifically component state nodes ES1, ES2 and ES3 for the output stages; L1, L2 and L3 for the lights; St1, St2, St3 and StM for the plug pins; and M for the grounding conductor. Their possible states are in each case defined by OK, US and NS, and the pertaining a priori probabilities are specified. The grounding conductor M does not receive the NS state. For the virtual ground component, a state node Ma is generated with the states OK, UB, NS and UB+NS. These states have no a priori probabilities.

Two nodes for input variables are generated for each component state node; one for the contact in the source direction, such as Li_Q, and one for the contact in the ground direction, such as L_NM. For simplifying the representation, in each case, only one component input node and one component output node is illustrated. The component state nodes ES1, ES2 and ES3 receive no component input node for the contact in the source direction, and the component state node M for the ground conductor receives no component input node for the contact in the ground direction. The output stages ES1, ES2, ES3 each receive a component input node Q1, Q2, Q3 with the “on” and “off” states. The component state node Ma for the virtual ground component receives a component input node Q with the states “source”, “no source” as well as a component input node M_UB with the states OK and UB. These nodes are used only for facilitating the modeling, but can be derived from the system description.

Furthermore, all component state nodes receive component output nodes which are imaged precisely like the component input nodes. For the component state node Ma for the ground component, this node is identical to the component state node itself, which is why it can be eliminated in this example.

The component functions are now modeled in that connections from component input nodes and component state nodes to the respective component output nodes are inserted. Likewise, the pertaining probability tables are specified.

For the overall state of the plug, two state nodes are generated, specifically node 148 “plug off” with the states OK and AB as well as node 146 with the states OK and “error”.

In the next step, the direct state relationships are imaged, as already explained in connection with FIG. 13. The possible “plug off” state acts directly on the state of all plug pins so that connections are inserted from the component state node “plug off” to all component state nodes St1, St2, St3 and StM. The probability tables of these component state nodes are specified such that, for the “plug off” state, all plug pins are interrupted. When the plug is not off, the a priori occurrence probabilities of the plug pins apply.

Furthermore, the states of the plug pins determine the state of the component state node 146 “plug”, so that connections are inserted from them to the node 146. The pertaining probability table is set up such that the state of the node 146 will only be OK when all plug pins are OK.

Then the component relationships are imaged such that the component output nodes of each component are connected with the component input nodes, with which they are connected according to the information of the circuit diagram in FIG. 12 in the direction of the respective information flow. As indicated above, only one component input node and one component output node respectively is illustrated for each component.

Finally, the system inputs and system outputs are linked. For this purpose, one connection respectively is generated between the system input nodes E1, E2, E3 and the inputs of the output stages ES1, ES2 and ES3. For simplifying the modeling, the input nodes of the output stages can be deleted and be replaced by system input nodes.

Furthermore, connections are inserted from nodes E1, E2, E3, Ql, Q2, Q3 and ES1_M, ES2_M, ES3_M to the corresponding nodes FC1, FC2 and FC3 respectively. The pertaining probability tables are determined by the deterministic functions of the output stages; for example, an output of the error code “interruption” will take place precisely when an output stage is connected but either its source connection or its ground connection is interrupted.

As a result, the Bayes network is fully specified. Because of the described setup, the constructed network can immediately be taken over into other networks without any change. Network fragments for individual components can also be taken over. As a result, changes of the technical system can rapidly be converted into a change of the Bayes network for the diagnosis.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for constructing a Bayes network for imaging and diagnosis of a technical system that is characterized by a system description, said process comprising:
constructing a system input node for each system input of the system;
constructing a system output node for each system output of the system;
imaging all components of the system by means of component state nodes, component input nodes and component output nodes;
constructing linkages between component state nodes of different components by means of direct logical and/or causal relationships between states of components;
constructing linkages between component output nodes and component input nodes of different components by way of flows of material, energy and/or information in the system;
constructing linkages between system input nodes and component input nodes by way of flows of material, energy and/or information in the system; and
constructing linkages between component output nodes and system output nodes by way of flows of material, energy and/or information in the system.

2. The process according to claim 1, wherein the step of constructing a system input node comprises establishing all possible states of the system input in the system input node.

3. The process according to claim 2, wherein an occurrence probability is assigned to each possible state of the system input.

4. The process according to claim 1, wherein the step of constructing the system output node comprises establishing all possible states of the system output in the system output node.

5. The process according to claim 1, wherein the step of imaging the components of the system comprises:
checking whether a component is constructed of partial components; and
if partial components are detected, all partial components are imaged by means of component state nodes, component input nodes and component output nodes.

6. The process according to claim 5, wherein another component state node for an overall function state is added to the imaging of a component that comprises partial components.

7. The process according to claim 1, wherein during imaging of the components:
a component state node is constructed for each component of the system;
a component input node is constructed for each input variable of a component; and
a component output node is constructed for each output variable of a component.

8. The process according to claim 7, wherein the step of establishing a component state node comprises:
establishing all possible function states of a particular component in the component state node; and
assigning an occurrence probability to each function state.

9. The process according to claim 7, wherein the step of establishing a component input node comprises establishing all possible states of input variables in a component input node.

10. The process according to claim 7, wherein the step of establishing a component output node comprises establishing all possible states of the output variables in the component output node.

11. The process according to claim 1, wherein the step of imaging the components of the system comprises constructing linkages within a component between a component input node and a component output node, and between a component state node and a component output node.

12. The process according to claim 11, wherein the step of constructing linkages within a component comprises assigning an occurrence probability to each possible state of a component output node as a function of the states of a linked component input node and a component state node.

13. The process according to claim 1, wherein the step of imaging components of the system comprises inserting network fragments from a component library.

14. The process according to claim 1, wherein the step of constructing linkages between component state nodes of different components comprises:
checking whether a function state of at least one component directly influences the state of another component;
inserting one connection respectively from each influencing component to the influenced component; and
assigning occurrence probabilities to each state of the influenced component as a function of the state of each influencing component.

15. The process according to claim 1, wherein the step of constructing linkages between component output nodes and a component input node of different components comprises assigning an occurrence probability to each state of the component input node, as a function of the state of each linked component output node.

16. The process according to claim 1, wherein the step of constructing linkages between system input nodes and a component input node comprises assigning an occurrence probability to each state of the component input node, as a function of a state of each linked system input node.

17. The process according to claim 1, wherein the step of constructing linkages between component output nodes and a system output node comprises assigning an occurrence probability to each state of the system output node, as a function of a state of each component output node.

18. A system for constructing a Bayes network for imaging and diagnosis of a technical system that is characterized by a system description, by performing the steps of
constructing a system input node for each system input of the system;
constructing a system output node for each system output of the system;
imaging all components of the system by means of component state nodes, component input nodes and component output nodes;
constructing linkages between component state nodes of different components by means of direct logical and/or causal relationships between states of components;
constructing linkages between component output nodes and component input nodes of different components by way of flows of material, energy and/or information in the system;
constructing linkages between system input nodes and component input nodes by way of flows of material, energy and/or information in the system; and
constructing linkages between component output nodes and system output nodes by way of flows of material, energy and/or information in the system; the system comprising:
a source unit for storage or editing of the system description;
a component analysis unit for analyzing the system and disassembling it into components;
a construction unit for constructing network fragments assigned to the components; and
a completion unit for assembling the network fragments to form an overall network.

19. The system according to claim 18, further comprising a component library for the storage of network fragments, wherein the construction unit can store and output network fragments in the component library.

20. The system according to claim 18, further comprising a setup control unit in which setup rules are filed for network components and network linkages, with the construction unit and the completion unit being able to take setup rules from the setup control unit.
